(19) United States
(12) Patent Application Publication
(10) Pub. No.: US 2016/0277271 A1
(43) Pub. Date: Sep. 22, 2016

(54) FAULT TOLERANT METHOD AND SYSTEM FOR MULTIPLE SERVERS

(71) Applicant: National Central University, Zhongli City (TW)

(72) Inventors: Wei-Jen Wang, Zhongli City (TW); Deron Liang, Taipei City (TW); Ching-Hwa Lee, Taipei City (TW)

(73) Assignee: National Central University, Zhongli City (TW)

(21) Appl. No.: 15/073,744

(22) Filed: Mar. 18, 2016

(30) Foreign Application Priority Data
Mar. 19, 2015 (TW) 104108745

(51) Int. Cl. H04L 12/26; H04L 12/24

(52) U.S. Cl. CPC H04L 43/0823; H04L 41/0654

(57) ABSTRACT

A fault tolerant method for multiple servers includes the following steps: sensing, by each server, a voltage of hardware of the server; receiving, by a cabinet manager, data of an operating state of a blade server and data of a voltage of hardware of each server; reading, by a monitoring server, the data of the operating state of the blade server and the data of the voltage of the hardware of a monitored server, where the data is transmitted by the monitored server in a cabinet manager; determining, by the monitoring server, whether the operating state of the blade server of the monitored server is faulty or whether the voltage of the hardware has no power supply; if the operating state of the blade server of the monitored server is faulty or the voltage of the hardware has no power supply, starting, by the monitoring server, a backup virtual machine; and restarting, by the cabinet manager, a faulty server.

### REFERENCE TO RELATED APPLICATIONS

This application claims priority to Taiwanese Patent Application No. 104108746, filed Mar. 19, 2015.

### TECHNICAL FIELD

The present invention relates to the field of computer technologies, and in particular, to a fault tolerant method and system for multiple servers.

### BACKGROUND

FIG. 1 is a block diagram of a conventional VMware computer cluster system. In FIG. 1, high availability of VMware (a virtual machine developer) ensures that hosts of a server constitute a cluster, and all hosts in the cluster elect one master host 10. A host that is connected to more data storage devices (datastore) 12 and 14 is more easily elected as the master host 10, where the data storage devices 12 and 14 are storage positions in which virtual machine image files are stored, and the storage position may be a virtual machine file system, an Internet-connected storage device file directory, or a local storage device file directory. Each cluster has only one master host 10, and other hosts are slave hosts 16. All slave hosts 16 transmit a connection signal to the master host 10, and also transmit a connection signal to the two (the number may be set) data storage devices 12 and 14 that are connected to the master host.

If the master host 10 fails to be connected to a slave host 16, the master host 10 queries the slave host 16, and if the slave host 16 do not reply to the query, the master host 10 checks whether the data storage devices 12 and 14 receive a connection signal from the slave host 16. If the master host 10 finds that neither of the data storage devices 12 and 14 receives the connection signal from the slave host 16, it is determined that the slave host 16 is faulty, and a virtual machine is restarted on another host; if the master host 10 finds that the data storage devices 12 and 14 receive the connection signal from the slave host 16, it is determined that there are network partitions, and a recovery procedure is not performed. In this case, some high-availability functions of VMware are degraded.

In the conventional VMware computer cluster system, the hosts of the server execute the virtual machine of a user, after a fault occurs in a host, much time needs to be spent in detecting the fault, recovering the virtual machine, and restarting a faulty machine till the machine returns to normal operations, which renders the fault tolerance efficiency of the system undesirable.

### SUMMARY

In view of the foregoing problems, an objective of the present invention provides a fault tolerant method and system for multiple servers, which can save, after a fault occurs in one of the servers, a lot of time in detecting the fault, recovering a virtual machine, and restarting a faulty machine till the machine returns to normal operations, improve fault tolerance efficiency of the system, and implement functions of detecting server hardware with an early warning and recovering a server.

A first aspect of the present invention provides a fault tolerant system for multiple servers, where the system includes a first server, a second server, and a cabinet manager, the first server and the second server monitor each other, and the first server includes:

a first voltage sensor, used to sense a voltage of hardware of the first server;

a first virtual machine manager, used to manage an operation of a virtual machine in the first server; and

a first monitor, used to read data of an operating state of a blade server of the second server and data of a voltage of hardware of the second server, where the data is transmitted by the second server monitored by the first server; determine whether the operating state of the blade server of the monitored second server is faulty or whether the voltage of the hardware has no power supply, and send a backup command to the first virtual machine manager so that the first virtual machine manager starts a backup virtual machine;

the second server includes:

a second voltage sensor, used to sense a voltage of hardware of the second server;

a second virtual machine manager, used to manage an operation of a virtual machine in the second server; and

a second monitor, used to read data of an operating state of a blade server of the first server and data of a voltage of hardware of the first server, where the data is transmitted by the first server monitored by the second server; determine whether the operating state of the blade server of the monitored first server is faulty or whether the voltage of the hardware has no power supply, and send a backup command to the second virtual machine manager so that the second virtual machine manager starts the backup virtual machine; and

the cabinet manager is used to receive the data of the operating states of the blade servers of the first server and the second server and the data of voltages of the hardware of the two servers, transmit the data to the first server or the second server, and restart the faulty first server or the faulty second server.

A second aspect of the present invention provides a fault tolerant system for multiple servers, where the system includes a first server, a second server, and a cabinet manager, the first server and the second server monitor each other, and the first server includes:

a first watchdog timer, used to begin countdown from a timing value and send out a timing completion signal when the countdown ends;

a first virtual machine manager, used to manage an operation of a virtual machine in the first server;

a first watchdog updater, used to send a reset signal to the first watchdog timer after a reset time elapses, to update the first watchdog timer so that the first watchdog timer begins countdown from the timing value; and

a first monitor, used to receive the timing completion signal that is transmitted by the second server monitored by the first server, and send a backup command according to the timing completion signal to the first virtual machine manager, so that the first virtual machine manager starts a backup virtual machine;

the second server includes:

a second watchdog timer, used to begin countdown from the timing value and send out the timing completion signal when the countdown ends;

a second virtual machine manager, used to manage an operation of a virtual machine in the second server;

a second watchdog updater, used to send the reset signal to the second watchdog timer after the reset time elapses, to update the second watchdog timer so that the second watchdog timer begins countdown from the timing value; and

a second monitor, used to receive the timing completion signal that is transmitted by the first server monitored by the second server, send the backup command according to the timing completion signal to the second virtual machine manager, so that the second virtual machine manager starts the backup virtual machine; and

the cabinet manager is used to receive the timing completion signal of the first server and the second server and transmit the timing completion signal to the first server or the second server, and restart the faulty first server or the faulty second server.

A third aspect of the present invention provides a fault tolerant system for multiple servers, where the system includes a first server, a second server, and a cabinet manager, and the first server and the second server monitor each other, where

the first server includes:

a first voltage sensor, used to sense a voltage of hardware of the first server;

a first virtual machine manager, used to manage an operation of a virtual machine in the first server; and

a first monitor, used to read data of a voltage of hardware that is transmitted by the second server monitored by the first server, determine whether the voltage of the hardware of the monitored second server reaches a dangerous threshold, and send a backup command to the first virtual machine manager so that the first virtual machine manager starts a backup virtual machine;

the second server includes:

a second voltage sensor, used to sense a voltage of hardware of the second server;

a second virtual machine manager, used to manage an operation of a virtual machine in the second server; and

a second monitor, used to read data of a voltage of hardware that is transmitted by the first server monitored by the second server, determine whether the voltage of the hardware of the monitored first server reaches a dangerous threshold, and send the backup command to the second virtual machine manager so that the second virtual machine manager starts the backup virtual machine; and

the cabinet manager is used to receive the data of the voltages of the hardware of the first server and the second server, transmit the data to the first server or the second server, and restart the faulty first server or the faulty second server.

A fourth aspect of the present invention provides a fault tolerant system for multiple servers, where the system includes a first server, a second server, and a cabinet manager, and the first server and the second server monitor each other, where

the first server includes:

a first temperature sensor, used to sense the temperature of the first server;

a first virtual machine manager, used to manage an operation of a virtual machine in the first server; and

a first monitor, used to read data of the temperature that is transmitted by the second server monitored by the first server, determine whether the temperature of the monitored second server reaches a dangerous threshold, and send a backup command to the first virtual machine manager so that the first virtual machine manager starts a backup virtual machine;

the second server includes:

a second temperature sensor, used to sense the temperature of the second server;

a second virtual machine manager, used to manage an operation of a virtual machine in the second server; and

a second monitor, used to read data of the temperature that is transmitted by the first server monitored by the second server, determine whether the temperature of the monitored first server reaches a dangerous threshold, and send a backup command to the second virtual machine manager so that the second virtual machine manager starts the backup virtual machine; and

the cabinet manager is used to receive the data of the temperature of the first server and the second server, transmit the data to the first server or the second server, and restart the faulty first server or the faulty second server.

A fifth aspect of the present invention provides a fault tolerant method for multiple servers, where the method includes the following steps:

sensing, by each server, a voltage of hardware of the server;

receiving, by a cabinet manager, data of an operating state of a blade server and data of a voltage of hardware of each server;

reading, by a monitoring server, the data of the operating state of the blade server and the data of the voltage of the hardware of a monitored server, where the data is transmitted by the monitored server in the cabinet manager;

determining, by the monitoring server, whether the operating state of the blade server of the monitored server is faulty or whether the voltage of the hardware has no power supply;

if the operating state of the blade server of the monitored server is faulty or the voltage of the hardware has no power supply, starting, by the monitoring server, a backup virtual machine; and restarting, by the cabinet manager, a faulty server.

A sixth aspect of the present invention provides a fault tolerant method for multiple servers, where the method includes the following steps:

beginning, by a watchdog timer of each server, countdown from a timing value;

sending, by each server, a reset signal to the corresponding watchdog timer after a reset time elapses, to update the corresponding watchdog timer so that the watchdog timer begins countdown from the timing value;

sending, by the watchdog timer, a timing completion signal to a cabinet manager when the watchdog timer ends the countdown;

if a monitoring server receives the timing completion signal that is sent by the watchdog timer of a monitored server in the cabinet manager, starting, by the monitoring server, a backup virtual machine; and

restarting, by the cabinet manager, a faulty server.

A seventh aspect of the present invention provides a fault tolerant method for multiple servers, where the method includes the following steps:

sensing, by each server, a voltage of hardware of the server;

receiving, by a cabinet manager, data of the voltage of the hardware of each server;

reading, by a monitoring server, data of a voltage of hardware of a monitored server, where the data is transmitted by the monitored server in the cabinet manager;

determining, by the monitoring server, whether the voltage of the hardware of the monitored server reaches a dangerous threshold;

if the voltage of the hardware of the monitored server reaches the dangerous threshold, starting, by the monitoring server, a backup virtual machine; and restarting, by the cabinet manager, a faulty server.

An eighth aspect of the present invention provides a fault tolerant method for multiple servers, where the method includes the following steps:

sensing, by each server, the temperature of the server;

receiving, by a cabinet manager, data of the temperature of each server;

reading, by a monitoring server, data of the temperature of a monitored server, where the data is transmitted by the monitored server in the cabinet manager;

determining, by the monitoring server, whether the temperature of the monitored server reaches a dangerous threshold;

if the temperature of the monitored server reaches the dangerous threshold, starting, by the monitoring server, a backup virtual machine; and

restarting, by the cabinet manager, a faulty server.

### BRIEF DESCRIPTION OF THE DRAWINGS

FIG. 1 is a block diagram of a conventional VMware computer cluster system;

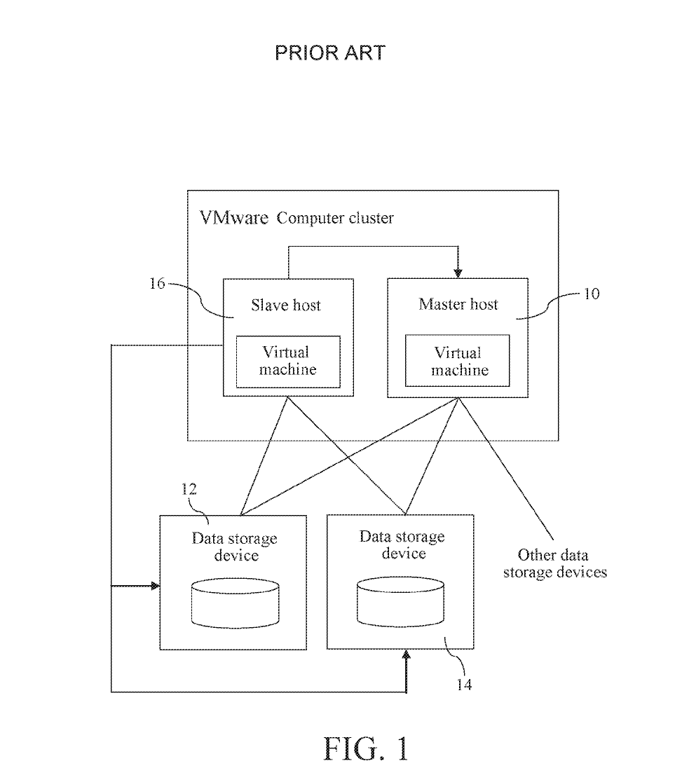

FIG. 2 is a block diagram of a fault tolerant system for multiple servers of the present invention; and

FIG. 3 is a flowchart of a fault tolerant method for multiple servers of the present invention.

### DETAILED DESCRIPTION

The fault tolerant system and method for multiple servers of the present invention will be described below in detail with reference to the following embodiments, and also as set forth in applicants' Taiwanese priority application No. 104108745, filed Mar. 19, 2015, the entire contents of which are hereby incorporated herein by reference. However, these embodiments are used mainly to assist in understanding the present invention, but not to restrict the scope of the present invention. Various possible modifications and alterations could be conceived of by one skilled in the art to the form and the content of any particular embodiment, without departing from the spirit and scope of the present invention, which is intended to be defined by the appended claims. Accordingly, to make a person of ordinary skill in the art to which the present invention relates further understand the present invention, the content constituting the present invention and the efficacy to be achieved by the present invention are illustrated below by using preferred embodiments of the present invention and with reference to the accompanying drawings.

Types of faults that may occur in an Advanced Telecommunications Computing Architecture (ATCA) industrial computer, kinds for describing the fault types, faults detected in different manners, and different corresponding recovery policies are uniformly integrated. An advanced recovery handler is a corresponding recovery policy that needs to be used to handle a complex fault. A fault tolerant system cannot perform recovery for all faults, and if there is a corresponding recovery policy, this method can be applied mechanically. The fault tolerant system may attempt to restart a blade server of a server, and set a recovery time and the number of restarts; and if the recovery limits are exceeded, report the situation to the server, to notify the server of a fault type due to which the operation cannot be implemented.

A virtualization technology is widely used, so that a physical server can be divided logically into multiple virtual machines to provide services of different types. However, in the virtualization technology, the service is interrupted due to faults caused by different reasons, for example, a failure in a physical machine affects a virtual machine executed thereon, which causes availability degradation of the virtual machine, and further affects a user in using a service on the virtual machine.

Types of faults that can be detected and a detection manner in a common computer architecture are limited, but in an ATCA industrial computer architecture supporting Intelligent Platform Management Interface (IPMI) hardware, a current state of hardware can be rapidly detected by using the IPMI and problems can be fast settled.

The ATCA industrial computer and the virtualization technology of a virtual machine manager are integrated to provide a matching fault tolerant system. In the fault tolerant system, the detection of faults in a server speeds up by using the ATCA hardware, the detected faults are categorized rapidly, and a corresponding recovery mechanism is found rapidly. Then, the fault tolerant system recovers a virtual machine in a faulty server on a corresponding virtual machine of a backup server, so as to reduce the effect of a single point (a server) failure on the virtual machine.

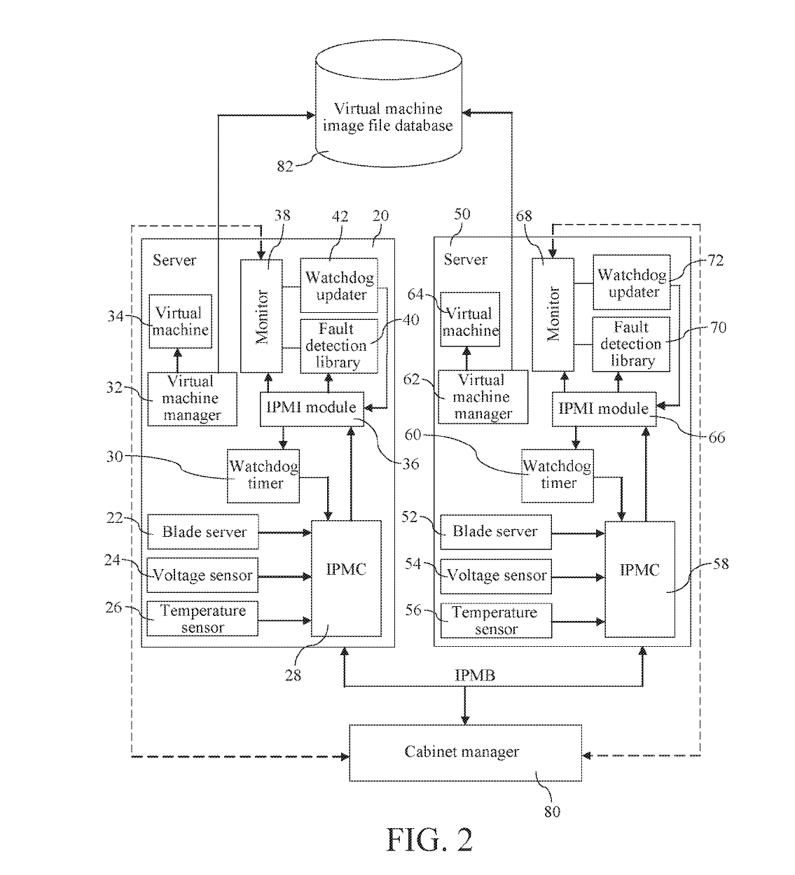

FIG. 2 is a block diagram of a fault tolerant system for multiple servers of the present invention. In FIG. 2, the fault tolerant system includes servers 20 and 50, a cabinet manager 80, and a virtual machine image file database 82. The server 20 and the server 50 monitor each other.

The server 20 includes a blade server 22, a voltage sensor 24, a temperature sensor 26, an Intelligent Platform Management Controller (IPMC) 28, a watchdog timer 30, a virtual machine manager 32, a virtual machine 34, an IPMI module 36, a monitor 38, a fault detection library 40, and a watchdog updater 42.

The server 50 includes a blade server 52, a voltage sensor 54, a temperature sensor 56, an IPMC 58, a watchdog timer 60, a virtual machine manager 62, a virtual machine 64, an IPMI module 66, a monitor 68, a fault detection library 70, and a watchdog updater 72.

In this embodiment, two servers are used to describe a fault tolerant system and method, but are not intended to limit the application of the present invention, and servers with any number are all applicable to the fault tolerant system and method of the present invention.

A core of the fault tolerant system in this embodiment is the monitors 38 and 68, where the monitors 38 and 68 integrate functions of the virtual machine managers 32 and 62 and the IPMI modules 36 and 66; the monitors 38 and 68 read data in the fault detection libraries 40 and 70; and the monitors 38 and 68 are set to monitor the servers 20 and 50 and the high-availability virtual machines 34 and 64, and are responsible for monitoring and performing recovery.

The monitors 38 and 68 are respectively installed in the servers 20 and 50, where the monitor 38 monitors operations of the server 50 and the virtual machine 64, and the monitor 68 monitors operations of the server 20 and the virtual machine 34. For example, the monitor 38 of the server 20 detects a state of the server 50 and starts a backup virtual machine of the server 20. For hardware, the IPMC 28 of the server 20 obtains data including a timing completion signal of the watchdog timer 30, a voltage sensed by the voltage sensor 24, the temperature sensed by the temperature sensor 26, and a field replaceable unit (FRU) state of the blade server 22, and receives, by using an Intelligent Platform Management Bus (IPMB), data such as a timing completion signal of the watchdog timer 60 of the server 50, a voltage sensed by the voltage sensor 54, and the temperature sensed by the temperature sensor 56 that are transmitted by the cabinet manager 80. The data such as the timing completion signal of the watchdog timer 60 of the server 50, the voltage sensed by the voltage sensor 54, and the temperature sensed by the temperature sensor 56 are transmitted to the fault detection library 40 by using the IPMC 28 and the IPMI module 36; the monitor 38 receives the FRU state of the blade server 52 of the server 50 from the cabinet manager 80 and reads, from the fault detection library 40, the data such as the timing completion signal of the watchdog timer 60 of the server 50, the voltage sensed by the voltage sensor 54, and the temperature sensed by the temperature sensor 56, and determines, according to the foregoing data, a type of a fault occurring in the server 50, so as to generate a corresponding fault recovery policy.

The monitor 38 monitors the server 50, and when the server 50 is faulty, the monitor 38 sends a backup command to the virtual machine manager 32; the virtual machine manager 32 starts a backup virtual machine, and the cabinet manager 80 restarts the faulty server 50.

The server 20 reads, from the virtual machine image file database 82, execution data corresponding to the backup virtual machine, and functions performed by the backup virtual machine are identical with those performed by a virtual machine of the faulty server.

Similarly, the server 50 executes the foregoing operations; and the monitor 68 monitors the server 20 and also executes the foregoing operations when the server 20 is faulty. The virtual machine manager 62 starts a backup virtual machine, and the cabinet manager 80 restarts the faulty server 20.

The fault tolerant system determines health conditions of the servers 20 and 50 in three detection manners, which are hot swap check, sensor check, and watchdog timer check.

In the hot swap check manner, startup states of hardware of the servers 20 and 50 are detected. For example, a blade server in an ATCA industrial computer has its own FRU state, the monitors 38 and 68 obtain FRU states of the blade servers in the monitoring servers 20 and 50 from the cabinet manager 80, and during the hot swap check, the FRU states of the blade servers are determined, where the FRU state indicates an operation state of hardware in a current blade server. The hot swap check aims to avoid that the blade server cannot be started due to a hardware reason (for example, a chassis undergoes a power shortage or some hardware is faulty).

In the sensor check, the temperature and the voltage of hardware of the servers 20 and 50 are detected, and the voltage sensors 24 and 54 and the temperature sensors 26 and 56 in the servers 20 and 50 vary in the number according to hardware design of the blade servers. The sensor check targets measurement states of hardware elements in the blade servers, including a CPU, a main board, a network card, and a power supply module.

The fault tolerant system estimates the hardware efficiency according to a sensing value of each sensor and a threshold thereof. If the sensing value exceeds the set threshold, a measure is taken to prevent a fault from occurring in the hardware, and recovery is performed and a fault type is returned according to a type sensed by the sensor.

In the watchdog timer check, system operations of the servers 20 and 50 are detected, and during the watchdog timer check, a watchdog timer in the ATCA industrial computer is used. The watchdog timer is a timing apparatus of computer hardware. If the server crashes (for example, an operating system crashes) or a timing value of the watchdog timer is not cleared regularly, the watchdog timer sends a reset signal, a reboot signal, or a turnoff signal to the fault tolerant system, so that the crashing server is restarted.

The watchdog timers 30 and 60 can examine a current timing value by using the IPMI modules 36 and 66, for example, query the current countdown seconds and how much time has passed since the timer is reset last time. The state of the blade server can also be obtained in such a manner, for example, the blade server is currently in a phase of a Basic Input Output System (BIOS) or has entered a phase of an operating system.

The watchdog timers 30 and 60 begin countdown from a timing value, and send a timing completion signal when the countdown ends. The watchdog updaters 42 and 72 send a reset signal to the watchdog timers 30 and 60 after a reset time elapses, to update the watchdog timers 30 and 60 so that the watchdog timers 30 and 60 begin countdown from the timing value. The monitors 38 and 68 can set the reset time of the watchdog updaters 42 and 72.

The reason why the server is turned off without a warning is that no power is supplied for the server for operation, or the server cannot operate when losing the power supply from the chassis. In the hot swap check and the sensor check, the case that the blade server has no power supply and the FRU state thereof leaves an M4 state (a normal operating state of the blade server) is detected, and it is considered that the servers 20 and 50 together with the virtual machines 34 and 64 stop operating. After the monitor of the monitoring server detects a fault, the virtual machine originally located on the faulty server starts a backup virtual machine on the monitoring server, and the cabinet manager 80 restarts the faulty server, and re-checks the faulty server so that the faulty server returns to normal operations.

Due to a fault of an operating system of the servers 20 and 50, all services are interrupted and the virtual machines 34 and 64 cannot operate; or because procedure execution is deadlocked or a memory is tampered, the operating system cannot give a response, so that the servers 20 and 50 present a started state but cannot operate. As a result, the watchdog updaters 42 and 72 do not reset a timing value for the watchdog timers 30 and 60, and the monitors 38 and 68 consider that the operating system cannot normally operate. The fault tolerant system restarts the backup virtual machine on a monitoring server, and restarts the faulty server.

Based on the temperature sensed by the temperature sensors 26 and 56 of the servers 20 and 50, hardware damage that is probably caused when the operation temperature exceeds a dangerous threshold is determined. In order to prevent severe hardware damage caused by overload of the system, the fault tolerant system restarts the backup virtual machine on the monitoring server, and restarts the faulty server. If the voltage detected by the voltage sensors 24 and 54 exceeds a dangerous threshold, in order to prevent system damage caused by a voltage exception, the fault tolerant system restarts the backup virtual machine on the monitoring server, turns off the faulty server, and classifies the faulty server as a server with a hardware problem.

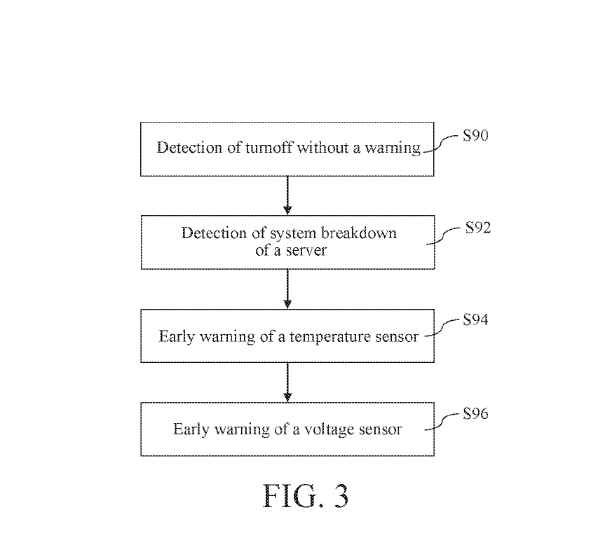

FIG. 3 is a flowchart of a fault tolerant method for multiple servers of the present invention. Steps in the process of FIG. 3 are described with reference to the components in FIG. 2.

In FIG. 3, a fault tolerant system detects the case that a server is turned off without a warning in a hot swap check manner and a sensor check manner (Step S90), and steps of detecting this case are described in detail below.

The voltage sensors 24 and 54 of the servers 20 and 50 sense a voltage of hardware of each of the servers 20 and 50. The IPMCs 28 and 58 obtain the voltage of the hardware that is sensed by the voltage sensors 24 and 54 and FRU states of the blade servers 22 and 52. The cabinet manager 80 receives, by using the IPMB, the voltage of the hardware that is sensed by the voltage sensors 24 and 54 and the FRU states of the blade servers 22 and 52 from the IPMCs 28 and 58.

In this embodiment, the server 20 and the server 50 monitor each other. The monitoring server 20 (or the server 50) reads data of an operating state of the blade server 52 (or the blade server 22) and data of a voltage of hardware of the monitored server 50 (or the server 20) in the cabinet manager 80, that is, the IPMC 28 (or the IPMC 58) receives, by using the IPMB, data of an operating state of the blade server 52 (or the blade server 22) and data of a voltage of hardware of the monitored server 50 (or the server 20) in the cabinet manager 80; and the IPMC 28 (or the IPMC 58) transmits, by using the IPMI module 36 (or the IPMI module 66), the data of the operating state of the blade server 52 (or the blade server 22) and the data of the voltage of the hardware of the server 50 (or the server 20) to the fault detection library 40 (or the fault detection library 70).

The monitor 38 of the server 20 (or the monitor 68 of the server 50) reads, from the fault detection library 40 (or the fault detection library 70), the data of the operating state of the blade server 52 (or the blade server 22) and the data of the voltage of the hardware of the server 50 (or the server 20), so as to determine whether the operating state of the blade server 52 (or the blade server 22) of the monitored server 50 (or the server 20) is faulty or whether the voltage of the hardware has no power supply.

If the reason why the server 50 (or the server 20) is turned off without a warning is that no power is supplied for the server 50 (or the server 20) for operation, or the server 50 (or the server 20) cannot operate when losing the power supply from the chassis, in the hot swap check and the sensor check, the case that the blade server 52 (or the blade server 22) has no power supply and the FRU state thereof leaves an M4 state (a normal operating state of the blade server) is detected, and it is considered that the server 50 (or the server 20) together with the virtual machine 64 (or the virtual machine 34) stops operating.

After the monitor 38 (or the monitor 68) of the monitoring server 20 (or the server 50) detects a fault, the virtual machine 64 (or the virtual machine 34) originally located on the faulty server 50 (or the server 20) starts a backup virtual machine on the monitoring server 20 (or the server 50), and the cabinet manager 80 restarts the faulty server 50 (or the server 20), and re-checks the faulty server 50 (or the server 20) so that the faulty server 50 (or the server 20) returns to normal operations.

The server 20 (or the server 50) reads, from the virtual machine image file database 82, execution data corresponding to the backup virtual machine, and functions performed by the backup virtual machine are identical with those performed by a virtual machine of the faulty server 50 (or the server 20).

In FIG. 3, the fault tolerant system detects, in a watchdog timer check manner, the case that an inner fault of an operating system of a server causes a service response failure (Step S92), and steps of detecting this case are described in detail below.

The watchdog timers 30 and 60 of the servers 20 and 50 begin countdown from a timing value. The watchdog updaters 42 and 72 of the servers 20 and 50 send a reset signal to the watchdog timers 30 and 60 after a reset time elapses, to update the watchdog timers 30 and 60 so that the watchdog timers 30 and 60 begin countdown from the timing value.

The watchdog timers 30 and 60 send a timing completion signal to the IPMCs 28 and 58 when the countdown ends, and the cabinet manager 80 receives, by using the IPMB, the timing completion signal transmitted by the IPMCs 28 and 58.

In this embodiment, the server 20 and the server 50 monitor each other. The monitoring server 20 (or the server 50) reads, by using the IPMB, the timing completion signal of the watchdog timer 60 (or the watchdog timer 30) of the monitored server 50 (or the server 20) in the cabinet manager 80, that is, the IPMC 28 (or the IPMC 58) receives, by using the IPMB, the timing completion signal of the watchdog timer 60 (or the watchdog timer 30) of the monitored server 50 (or the server 20) in the cabinet manager 80; the IPMC 28 (or the IPMC 58) transmits, by using the IPMI module 36 (or the IPMI module 66), the timing completion signal of the watchdog timer 60 (or the watchdog timer 30) of the monitored server 50 (or the server 20) to the monitor 38 (or the monitor 68).

The monitor 38 of the server 20 (or the monitor 68 of the server 50) determines, according to whether the watchdog timer 60 (or the watchdog timer 30) of the server 50 (or the server 20) sends the timing completion signal, the case that an inner fault of a server operating system of the monitored server 50 (or the server 20) causes a service response failure.

Due to a fault of an operating system of the server 50 (or the server 20), all services are interrupted and the virtual machine 64 (or the virtual machine 34) cannot operate; or because procedure execution is deadlocked or a memory is tampered, the operating system cannot give a response, so that the server 50 (or the server 20) presents a started state but cannot operate. As a result, the watchdog updater 72 (or the watchdog updater 42) does not reset a timing value for the watchdog timer 60 (or the watchdog timer 30), the monitor 38 (or the monitor 68) considers that the operating system of the server 50 (or the server 20) cannot normally operate, and the monitor 38 (or the monitor 68) sends a backup command to the virtual machine manager 32 (or the virtual machine manager 62), so that the virtual machine manager 32 (or the virtual machine manager 62) starts a backup virtual machine; and the cabinet manager 80 restarts the faulty server 50 (or the server 20), and re-checks the faulty server 50 (or the server 20) so that the server returns to normal operations.

The server 20 (or the server 50) reads, from the virtual machine image file database 82, execution data corresponding to the backup virtual machine, and functions performed by the backup virtual machine are identical with those performed by a virtual machine of the faulty server 50 (or the server 20).

In FIG. 3, the fault tolerant system detects, in a sensor check manner, the case that the temperature sensed by a temperature sensor of a server reaches a dangerous threshold (Step S94), and steps of detecting this case are described in detail below.

The temperature sensors 26 and 56 of the servers 20 and 50 sense the temperature of hardware of each of the servers 20 and 50. The IPMCs 28 and 58 obtain the temperature of the hardware that is sensed by the temperature sensors 26 and 56. The cabinet manager 80 receives, by using the IPMB, the temperature of the hardware that is sensed by the temperature sensors 26 and 56 from the IPMCs 28 and 58.

In this embodiment, the server 20 and the server 50 monitor each other. The monitoring server 20 (or the server 50) reads data of the temperature of the hardware of the monitored server 50 (or the server 20) in the cabinet manager 80, that is, the IPMC 28 (or the IPMC 58) receives, by using the IPMB, the data of the temperature of the hardware of the monitored server 50 (or the server 20) in the cabinet manager 80; and the IPMC 28 (or the IPMC 58) transmits, by using the IPMI module 36 (or the IPMI module 66), the data of the temperature of the hardware of the server 50 (or the server 20) to the fault detection library 40 (or the fault detection library 70).

The monitor 38 of the server 20 (or the monitor 68 of the server 50) reads the data of the temperature of the hardware of the server 50 (or the server 20) from the fault detection library 40 (or the fault detection library 70), the monitor 38 (or the monitor 68) determines, based on the temperature sensed by the temperature sensor 56 (or the temperature sensor 26) of the server 50 (or the server 20), whether the operation temperature of the server 50 (or the server 20) exceeds a dangerous threshold to probably cause hardware damage of the server 50 (or the server 20).

In order to prevent hardware damage caused by overload of the server 50 (or the server 20), if the monitor 38 (or the monitor 68) determines that the temperature of the monitored server 50 (or the server 20) reaches the dangerous threshold, the monitor 38 (or the monitor 68) sends a backup command to the virtual machine manager 32 (or the virtual machine manager 62), so that the virtual machine manager 32 (or the virtual machine manager 62) starts a backup virtual machine; and the cabinet manager 80 restarts the faulty server 50 (or the server 20), and re-checks the faulty server 50 (or the server 20) so that the server returns to normal operations.

The server 20 (or the server 50) reads, from the virtual machine image file database 82, execution data corresponding to the backup virtual machine, and functions performed by the backup virtual machine are identical with those performed by a virtual machine of the faulty server 50 (or the server 20).

In FIG. 3, the fault tolerant system detects, in a sensor check manner, the case that a voltage sensed by a voltage sensor of a server reaches a dangerous threshold (Step S96), and steps of detecting this case are described in detail below.

The voltage sensors 24 and 54 of the servers 20 and 50 sense a voltage of hardware of each of the servers 20 and 50. The IPMCs 28 and 58 obtain a voltage of the hardware that is sensed by the voltage sensors 24 and 54. The cabinet manager 80 receives, by using the IPMB, the voltage of the hardware that is sensed by the voltage sensors 24 and 54 from the IPMCs 28 and 58.

In this embodiment, the server 20 and the server 50 monitor each other. The monitoring server 20 (or the server 50) reads data of the voltage of the hardware of the monitored server 50 (or the server 20) in the cabinet manager 80, that is, the IPMC 28 (or the IPMC 58) receives, by using the IPMB, the data of the voltage of the hardware of the monitored server 50 (or the server 20) in the cabinet manager 80; and the IPMC 28 (or the IPMC 58) transmits, by using the IPMI module 36 (or the IPMI module 66), the data of the voltage of the hardware of the server 50 (or the server 20) to the fault detection library 40 (or the fault detection library 70).

The monitor 38 of the server 20 (or the monitor 68 of the server 50) reads the data of the voltage of the hardware of the server 50 (or the server 20) from the fault detection library 40 (or the fault detection library 70), to determine whether the voltage of the monitored server 50 (or the server 20) reaches a dangerous threshold.

If the voltage detected by the voltage sensors 24 and 54 reaches the dangerous threshold, in order to prevent damage of the server 50 (or the server 20) due to a voltage exception, the monitor 38 (or the monitor 68) sends a backup command to the virtual machine manager 32 (or the virtual machine manager 62), so that the virtual machine manager 32 (or the virtual machine manager 62) starts a backup virtual machine, turns off the faulty server 50 (or the server 20), and classifies the faulty server 50 (or the server 20) as a server with a hardware problem.

The server 20 (or the server 50) reads, from the virtual machine image file database 82, execution data corresponding to the backup virtual machine, and functions performed by the backup virtual machine are identical with those performed by a virtual machine of the faulty server 50 (or the server 20).

The present invention provides a fault tolerant method and system for multiple servers, which have the following advantages. After a fault occurs in one of the servers, a lot of time can be saved in detecting the fault, recovering a virtual machine, and restarting a faulty machine till the machine returns to normal operations, fault tolerance efficiency of the system can be improved, and functions of detecting server hardware with an early warning and recovering a server are implemented.

The present invention has been described above with reference to preferred embodiments and exemplary accompanying drawings, but is not intended to be limited thereto. Various modifications, omissions, and changes made to the type and specific content of the present invention by a person skilled in the art still fall within the scope defined by the claims of the present invention.

What is claimed is:

1. A fault tolerant system for multiple servers, wherein the system comprises a first server, a second server, and a cabinet manager, and the first server and the second server monitor each other, wherein
the first server comprises:
a first voltage sensor, used to sense a voltage of hardware of the first server;
a first virtual machine manager, used to manage an operation of a virtual machine in the first server; and
a first monitor, used to read data of an operating state of a blade server of the second server and data of a voltage of hardware of the second server, wherein the data is transmitted by the second server monitored by the first server; determine whether the operating state of the blade server of the monitored second server is faulty or whether the voltage of the hardware has no power supply, and send a backup command to the first virtual machine manager so that the first virtual machine manager starts a backup virtual machine;
the second server comprises:
a second voltage sensor, used to sense a voltage of hardware of the second server;
a second virtual machine manager, used to manage an operation of a virtual machine in the second server; and
a second monitor, used to read data of an operating state of a blade server of the first server and data of a voltage of hardware of the first server, wherein the data is transmitted by the first server monitored by the second server; determine whether the operating state of the blade server of the monitored first server is faulty or whether the voltage of the hardware has no power supply, and send a backup command to the second virtual machine manager so that the second virtual machine manager starts the backup virtual machine; and
the cabinet manager is used to receive the data of the operating states of the blade servers of the first server and the second server and the data of voltages of the hardware of the two servers, transmit the data to the first server or the second server, and restart the faulty first server or the faulty second server.

2. The system according to claim 1, wherein
the first server comprises:
a first Intelligent Platform Management Controller (IPMC), used to receive the data of the operating state of the blade server and data of the voltage sensed by the first voltage sensor, transmit the data to the cabinet manager, and receive the data, transmitted by the cabinet manager, of the voltage of the hardware of the second server monitored by the first server;
a first Intelligent Platform Management Interface (IPMI) module, used to receive the data, transmitted by the first IPMC, of the voltage of the hardware of the second server monitored by the first server;
a first fault detection library, used to store the data, transmitted by the first IPMI module, of the voltage of the hardware of the second server monitored by the first server; and
the first monitor, used to read the data, in the first fault detection library, of the voltage of the hardware of the second server monitored by the first server;
the second server comprises:
a second IPMC, used to receive the data of the operating state of the blade server and data of the voltage sensed by the second voltage sensor, transmit the data to the cabinet manager, and receive the data, transmitted by the cabinet manager, of the voltage of the hardware of the first server monitored by the second server;
a second IPMI module, used to receive the data, transmitted by the second IPMC, of the voltage of the hardware of the first server monitored by the second server;
a second fault detection library, used to store the data, transmitted by the second IPMI module, of the voltage of the hardware of the first server monitored by the second server; and
the second monitor, used to read the data, in the second fault detection library, of the voltage of the hardware of the first server monitored by the second server.

3. The system according to claim 1, further comprising:
a virtual machine image file database, used to store execution data of the virtual machines of the first server and the second server, so that the first server or the second server reads virtual machine execution data corresponding to the backup virtual machine.

4. A fault tolerant system for multiple servers, wherein the system comprises a first server, a second server, and a cabinet manager, and the first server and the second server monitor each other, wherein
the first server comprises:
a first watchdog timer, used to begin countdown from a timing value and send out a timing completion signal when the countdown ends;
a first virtual machine manager, used to manage an operation of a virtual machine in the first server;
a first watchdog updater, used to send a reset signal to the first watchdog timer after a reset time elapses, to update the first watchdog timer so that the first watchdog timer begins countdown from the timing value; and
a first monitor, used to receive the timing completion signal that is transmitted by the second server monitored by the first server, and send a backup command according to the timing completion signal to the first virtual machine manager, so that the first virtual machine manager starts a backup virtual machine;
the second server comprises:
a second watchdog timer, used to begin countdown from the timing value and send out the timing completion signal when the countdown ends;
a second virtual machine manager, used to manage an operation of a virtual machine in the second server;
a second watchdog updater, used to send the reset signal to the second watchdog timer after the reset time elapses, to update the second watchdog timer so that the second watchdog timer begins countdown from the timing value; and
a second monitor, used to receive the timing completion signal that is transmitted by the first server monitored by the second server, send the backup command according to the timing completion signal to the second virtual machine manager, so that the second virtual machine manager starts the backup virtual machine; and
the cabinet manager is used to receive the timing completion signal of the first server and the second server and transmit the timing completion signal to the first server or the second server, and restart the faulty first server or the faulty second server.

5. The system according to claim 4, wherein
the first server comprises:
a first IPMC, used to receive the timing completion signal sent by the first watchdog timer, transmit the timing completion signal to the cabinet manager, and receive the timing completion signal, transmitted by the cabinet manager, of the second server monitored by the first server;
a first IPMI module, used to receive the timing completion signal, transmitted by the first IPMC, of the second server monitored by the first server; and
the first monitor, used to receive the timing completion signal, transmitted by the first IPMI module, of the second server monitored by the first server;
the second server comprises:
a second IPMC, used to receive the timing completion signal sent by the second watchdog timer, transmit the timing completion signal to the cabinet manager, and receive the timing completion signal, transmitted by the cabinet manager, of the first server monitored by the second server;
a second IPMI module, used to receive the timing completion signal, transmitted by the second IPMC, of the first server monitored by the second server; and
the second monitor, used to receive the timing completion signal, transmitted by the second IPMI module, of the first server monitored by the second server.

6. The system according to claim 4, further comprising:
a virtual machine image file database, used to store execution data of the virtual machines of the first server and the second server, so that the first server or the second server reads virtual machine execution data corresponding to the backup virtual machine.

7. A fault tolerant system for multiple servers, wherein the system comprises a first server, a second server, and a cabinet manager, and the first server and the second server monitor each other, wherein
the first server comprises:
a first voltage sensor, used to sense a voltage of hardware of the first server;
a first virtual machine manager, used to manage an operation of a virtual machine in the first server; and
a first monitor, used to read data of a voltage of hardware that is transmitted by the second server monitored by the first server, determine whether the voltage of the hardware of the monitored second server reaches a dangerous threshold, and send a backup command to the first virtual machine manager so that the first virtual machine manager starts a backup virtual machine;
the second server comprises:
a second voltage sensor, used to sense a voltage of hardware of the second server;
a second virtual machine manager, used to manage an operation of a virtual machine in the second server; and
a second monitor, used to read data of a voltage of hardware that is transmitted by the first server monitored by the second server, determine whether the voltage of the hardware of the monitored first server reaches a dangerous threshold, and send the backup command to the second virtual machine manager so that the second virtual machine manager starts the backup virtual machine; and
the cabinet manager is used to receive the data of the voltages of the hardware of the first server and the second server, transmit the data to the first server or the second server, and restart the faulty first server or the faulty second server.

8. The system according to claim 7, wherein
the first server comprises:
a first IPMC, used to receive data of the voltage sensed by the first voltage sensor, transmit the data to the cabinet manager, and receive the data, transmitted by the cabinet manager, of the voltage of the hardware of the second server monitored by the first server;
a first IPMI module, used to receive the data, transmitted by the first IPMC, of the voltage of the hardware of the second server monitored by the first server;
a first fault detection library, used to store the data, transmitted by the first IPMI module, of the voltage of the hardware of the second server monitored by the first server; and
the first monitor, used to read the data, in the first fault detection library, of the voltage of the hardware of the second server monitored by the first server;
the second server comprises:
a second IPMC, used to receive data of the voltage sensed by the second voltage sensor, transmit the data to the cabinet manager, and receive the data, transmitted by the cabinet manager, of the voltage of the hardware of the first server monitored by the second server;
a second IPMI module, used to receive the data, transmitted by the second IPMC, of the voltage of the hardware of the first server monitored by the second server;
a second fault detection library, used to store the data, transmitted by the second IPMI module, of the voltage of the hardware of the first server monitored by the second server; and
the second monitor, used to read the data, in the second fault detection library, of the voltage of the hardware of the first server monitored by the second server.

9. The system according to claim 7, further comprising:
a virtual machine image file database, used to store execution data of the virtual machines of the first server and the second server, so that the first server or the second server reads virtual machine execution data corresponding to the backup virtual machine.

10. A fault tolerant system for multiple servers, wherein the system comprises a first server, a second server, and a cabinet manager, and the first server and the second server monitor each other, wherein
the first server comprises:
a first temperature sensor, used to sense the temperature of the first server;
a first virtual machine manager, used to manage an operation of a virtual machine in the first server; and
a first monitor, used to read data of the temperature that is transmitted by the second server monitored by the first server, determine whether the temperature of the monitored second server reaches a dangerous threshold, and send a backup command to the first virtual machine manager so that the first virtual machine manager starts a backup virtual machine;
the second server comprises:
a second temperature sensor, used to sense the temperature of the second server;
a second virtual machine manager, used to manage an operation of a virtual machine in the second server; and
a second monitor, used to read data of the temperature that is transmitted by the first server monitored by the second server, determine whether the temperature of the monitored first server reaches a dangerous threshold, and send a backup command to the second virtual machine manager so that the second virtual machine manager starts the backup virtual machine; and
the cabinet manager is used to receive the data of the temperature of the first server and the second server, transmit the data to the first server or the second server, and restart the faulty first server or the faulty second server.

11. The system according to claim 10, wherein
the first server comprises:
a first IPMC, used to receive data of the temperature sensed by the first temperature sensor, transmit the data to the cabinet manager, and receive the data, transmitted by the cabinet manager, of the temperature of the second server monitored by the first server;
a first IPMI module, used to receive the data, transmitted by the first IPMC, of the temperature of the second server monitored by the first server;
a first fault detection library, used to store the data, transmitted by the first IPMI module, of the temperature of the second server monitored by the first server; and
the first monitor, used to read the data, in the first fault detection library, of the temperature of the second server monitored by the first server;
the second server comprises:
a second IPMC, used to receive data of the temperature sensed by the second temperature sensor, transmit the data to the cabinet manager, and receive the data, transmitted by the cabinet manager, of the temperature of the first server monitored by the second server;
a second IPMI module, used to receive the data, transmitted by the second IPMC, of the temperature of the first server monitored by the second server;
a second fault detection library, used to store the data, transmitted by the second IPMI module, of the temperature of the first server monitored by the second server; and
the second monitor, used to read the data, in the second fault detection library, of the temperature of the first server monitored by the second server.

12. The system according to claim 10, further comprising:
a virtual machine image file database, used to store execution data of the virtual machines of the first server and the second server, so that the first server or the second server reads virtual machine execution data corresponding to the backup virtual machine.

13. A fault tolerant method for multiple servers, comprising the following steps:
sensing, by each server, a voltage of hardware of the server;
receiving, by a cabinet manager, data of an operating state of a blade server and data of a voltage of hardware of each server;
reading, by a monitoring server, the data of the operating state of the blade server and the data of the voltage of the hardware of a monitored server, wherein the data is transmitted by the monitored server in the cabinet manager;
determining, by the monitoring server, whether the operating state of the blade server of the monitored server is faulty or whether the voltage of the hardware has no power supply;
if the operating state of the blade server of the monitored server is faulty or the voltage of the hardware has no power supply, starting, by the monitoring server, a backup virtual machine; and
restarting, by the cabinet manager, a faulty server.

14. A fault tolerant method for multiple servers, comprising the following steps:
beginning, by a watchdog timer of each server, countdown from a timing value;
sending, by each server, a reset signal to the corresponding watchdog timer after a reset time elapses, to update the corresponding watchdog timer so that the watchdog timer begins countdown from the timing value;
sending, by the watchdog timer, a timing completion signal to a cabinet manager when the watchdog timer ends the countdown;
if a monitoring server receives the timing completion signal that is sent by the watchdog timer of a monitored server in the cabinet manager, starting, by the monitoring server, a backup virtual machine; and
restarting, by the cabinet manager, a faulty server.

15. A fault tolerant method for multiple servers, comprising the following steps:
sensing, by each server, a voltage of hardware of the server;
receiving, by a cabinet manager, data of the voltage of the hardware of each server;
reading, by a monitoring server, data of a voltage of hardware of a monitored server, wherein the data is transmitted by the monitored server in the cabinet manager;
determining, by the monitoring server, whether the voltage of the hardware of the monitored server reaches a dangerous threshold;
if the voltage of the hardware of the monitored server reaches the dangerous threshold, starting, by the monitoring server, a backup virtual machine; and
restarting, by the cabinet manager, a faulty server.

16. A fault tolerant method for multiple servers, comprising the following steps:
sensing, by each server, the temperature of the server;
receiving, by a cabinet manager, data of the temperature of each server;
reading, by a monitoring server, data of the temperature of a monitored server, where the data is transmitted by the monitored server in the cabinet manager;
determining, by the monitoring server, whether the temperature of the monitored server reaches a dangerous threshold;
if the temperature of the monitored server reaches the dangerous threshold, starting, by the monitoring server, a backup virtual machine; and
restarting, by the cabinet manager, a faulty server.

17. The method according to claim 13 wherein the step of starting, by the monitoring server, a backup virtual machine comprises:
reading, by the monitoring server from a virtual machine image file database, virtual machine execution data corresponding to the backup virtual machine.

18. The method according to claim 14, wherein the step of starting, by the monitoring server, a backup virtual machine comprises:
reading, by the monitoring server from a virtual machine image file database, virtual machine execution data corresponding to the backup virtual machine.

19. The method according to claim 15, wherein the step of starting, by the monitoring server, a backup virtual machine comprises:
reading, by the monitoring server from a virtual machine image file database, virtual machine execution data corresponding to the backup virtual machine.

20. The method according to claim 16, wherein the step of starting, by the monitoring server, a backup virtual machine comprises:
reading, by the monitoring server from a virtual machine image file database, virtual machine execution data corresponding to the backup virtual machine.
